(19) United States
(12) Patent Application Publication
(10) Pub. No.: US 2011/0067649 A1
(43) Pub. Date: Mar. 24, 2011

(54) Non-Tangle dual animal extending leash device

(76) Inventors: Carolyn O'Brien, Roswell, GA (US); John Evans, Sandy Springs, GA (US)

(21) Appl. No.: 12/807,493

(22) Filed: Sep. 7, 2010

Related U.S. Application Data
(60) Provisional application No. 61/240,206, filed on Sep. 5, 2009.

(51) Int. Cl. A01K 27/00

(52) U.S. Cl. 119/796

(57) ABSTRACT

A no-tangle, retractable leash device for more than one tethered entity, the leash device. The device includes a handle and a housing rotatably carried by the handle. The housing having an interior and at least a first and second aperture communicating the interior with the ambient environment. The device also includes at least a first and second leash reel carried within the housing. The first and second leash reels each carrying a respective leash and being independently rotatable enabling a respective leash to extend through a respective aperture of the housing. A brake inhibits the rotational movement of at least one reel.

### CLAIM OF PRIORITY

This application claims priority to U.S. Provisional Application 61/240206 filed on Sep. 5, 2009 entitled Tangle-Free Extendable Leashes to the inventor Carolyn Reaves O′Brien which is incorporated by reference in its entirety.

### FIELD OF INVENTION

The technology described herein relates generally to leashes for pets. More specifically, this technology relates to non-tangle, retractable extension leashes for walking, restraining, and so forth, of pets, or other tethered entities.

### BACKGROUND OF THE INVENTION

Of the estimated 77.5 million owned dogs in the United States, almost 20 million of those dogs live in a household that owns two dogs. Dog walking is the most common and universal way to exercise these animals and daily walks are highly recommended for physical and psychological benefits. For the person walking two or more dogs, this can become quite challenging, especially when using multiple leashes. As dogs move constantly, leashes easily crisscross and often a leash is dropped in an effort to detangle them. When multiple extending type leashes are used in the process of walking two or more dogs, the walker inevitably is bound to have to maneuver the leashes to prevent entanglement as well as manage the length to which they extend. In an effort to minimize these problems, there have been a several devices developed to help walk more than one dog on extending style leashes.

U.S. Pat. No. 6,792,893, issued to Quintero et al. on Sep. 21, 2004, discloses a retractable two-pet leash. U.S. Pat. No. 7,207,296, issued to DiDonato on Apr. 24, 2007, discloses a no-tangle two dog retractable leash with flashlight. U.S. Published Patent Application No. 2008/0000433 filed by DiDonato and published on Jan. 3, 2008, discloses a no-tangle two dog retractable leash.

While suitable for their intended purposes, applicant believes innovations are necessary for ensuring the non-tangling of the leashes. Accordingly, it is an object of the present invention to provide for a device which provides for walking at least two tethered animals in a manner which facilitates in the non-tangling of the respective leashes.

### SUMMARY OF THE INVENTION

The invention consists of at least a plurality of reels for manipulating leashes which are housed within a leash housing. The leash housing has a plurality of apertures enabling the respective leashes to extend from its respective reel to the outside ambient environment. The housing is rotatable enabling a respective leash to correspondingly rotate around a center of the housing. A handle is utilized for carrying the leash housing and respective reels. A braking mechanism carried in the vicinity of the handle enables the operator to terminate the movement of the respective reels and subsequent extension of the respective leashes.

### BRIEF DESCRIPTION OF THE DRAWINGS

The technology described herein is illustrated with reference to the various drawings, in which like reference numbers denote like device components and/or method steps, respectively, and in which:

FIG. 1 is a perspective view of a non-tangle, retractable extension leash, illustrating, in particular, use of the device in walking two tethered entities, according to an embodiment of the technology described herein;

FIG. 2 is a side perspective view of the non-tangle, retractable extension leash, illustrating, in particular, the handle, button, and housings, according to an embodiment of the technology described herein;

FIG. 3 is a side perspective view of the non-tangle, retractable extension leash, illustrating, in particular, the handle and the button and their associated interconnectivity with the bearing, according to an embodiment of the technology described herein; and

FIG. 4 is an expanded front perspective view of the non-tangle, retractable extension leash, illustrating, in particular, the assembly and interconnectivity of elements of the leash, according to an embodiment of the technology described herein;

FIG. 5 is an exploded view of an alternative embodiment of the invention showing the approximate position of each component;

FIG. 6A is an exploded detailed view of that portion of the invention concerned with the operation and mounting of those components directly involved with the extension and retraction of the two leashes;

FIG. 6B is an isometric view of the assembled components described in FIG. 6A;

FIG. 7 is a detailed view showing the placement of all components comprising the right half of the invention of the alternative embodiment;

FIG. 8 is a detailed view showing the placement of all components comprising the left half of the alternative embodiment;

FIG. 9A is a simplified right hand view depicting the position of the operating button in the neutral position;

FIG. 9B is a simplified right hand view depicting the position of the operating button in the engaged position;

FIG. 9C is a simplified right hand view depicting the position of the operating button in the engaged and locked position;

FIG. 10A is a simplified left hand view showing the position of the operating button in the neutral position;

FIG. 10B is a simplified left hand view showing the position of the left operating button in the engaged position;

FIG. 10C is a simplified left hand view showing the position of the left operating button in the engaged and locked position;

FIG. 11A is an isometric view of the invention showing the location of externally attached components and associated attachment points;

FIG. 11B is a side view of the alternative embodiment of the invention illustrating the rotation capabilities of the leash housing; and

FIG. 12 illustrates an alternative embodiment utilizing a braking mechanism for a dual button configuration.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

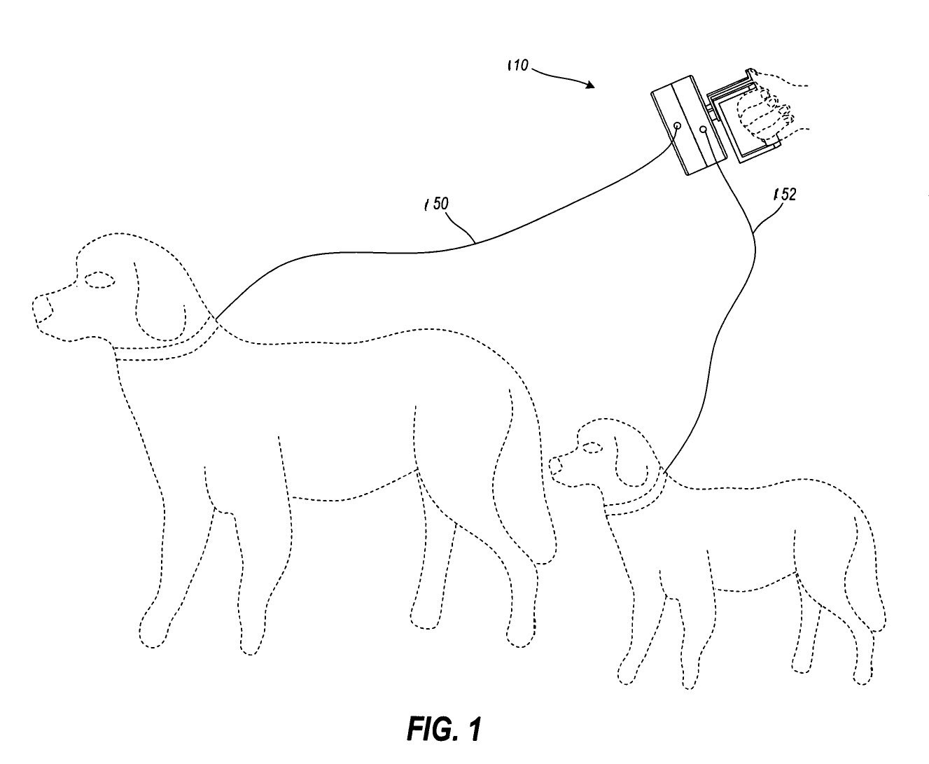

Referring now to the FIG. 1, a non-tangle, retractable extension leash 110 device is shown. The device 110 is shown in use for walking two tethered entities, with a first leash 150 attached to one tethered entity and a second leash 152 attached to a second tethered entity. The device 110 can be used for a single tethered entity, two tethered entity, or multiple tethered entities dependent on the number of leash wheels included within. The device 110 provides extendable leashes 150, 152 for multiple tethered entities in a device 10 with ergonomic functionality and design. The device 110 is manufactured from lightweight, yet sturdy and durable, materials. The extendable leashes 150, 152 can be interchangeable. As such, replacement leashes can be added or leashes of alternative lengths and strengths can be utilized. The device 110 is configured to accommodate multiple leashes from a single hand operable device in an orderly fashion without the dreaded leash entanglement scenarios.

The device 110 is configured to avoid leash entanglement while in use with multiple leashes. The device 110 provides for leashes 150, 152 with independent rotation about their axes of rotation. Additionally, the device 110 provides for single-handed operation of both the device handle 112 and braking mechanism 116 to stop the extension of the leashes 150, 152 to the tethered entities.

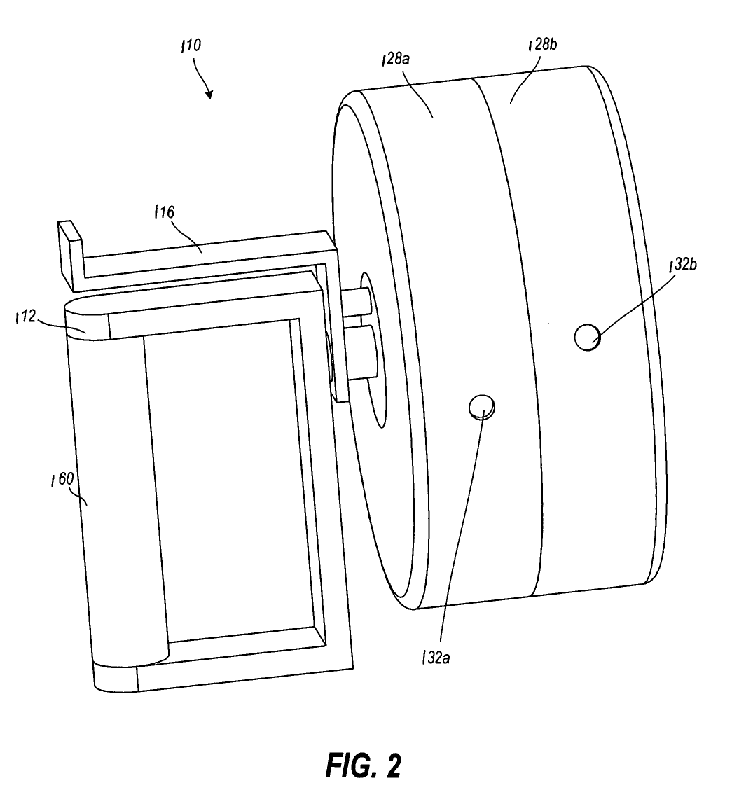

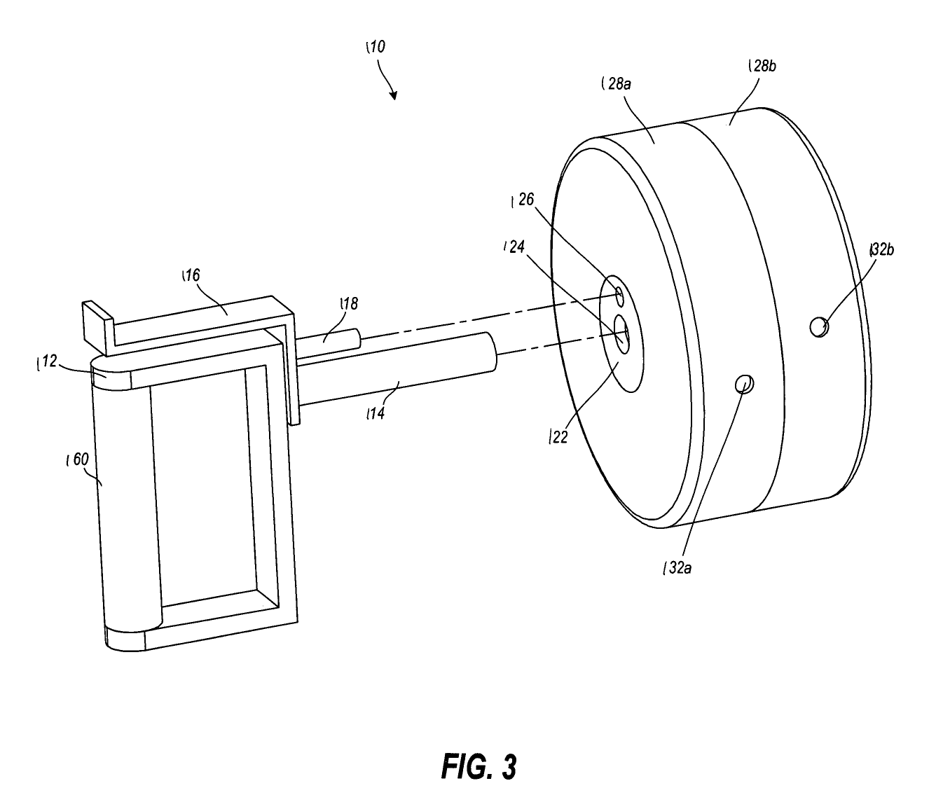

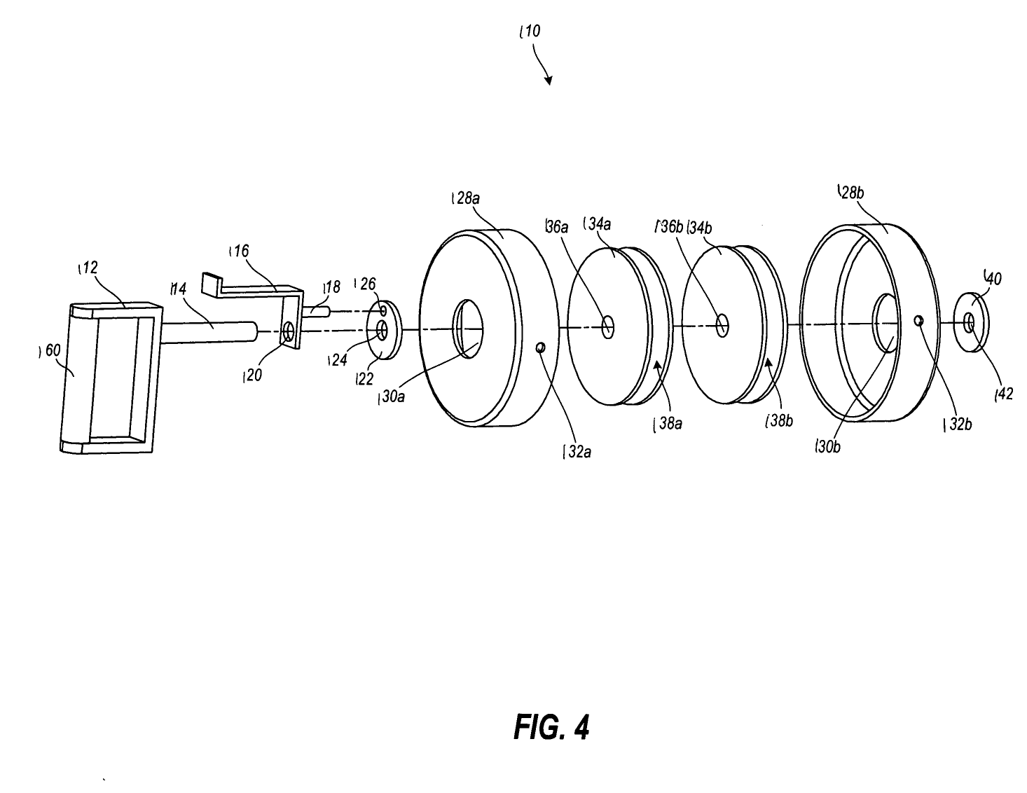

Referring now to FIGS. 2, 3, and 4, a non-tangle, retractable extension leash 110 is shown. The device 110 includes first and second wheels 134a, 134b. Additional wheels can be utilized for embodiments of the device configured for more than two leashes. The first and second wheels 134a, 134b are shaped as spools and are mounted on an axle 114 through holes 136a, 136b, respectively.

The first and second wheels 134a, 134b are configured to rotate independently on the axle 114. Each wheel 134a, 134b is configured to hold a leash 150, 152 in leash groove 138a, 138b and to retract the leash when low tension on the leash exists. The first and second wheels 134a, 134b are configured such that the leashes 150, 152 do not entangle when the leashes are extended and retracted while in use. Disposed within the each retractable wheel 134a, 134b is a torsional spring (not shown). As a leash 150, 152 is extended outwardly from the device 110, the torsional spring wraps around the spindle in the center of the wheel 134a, 134b. The torsional spring wrap provides tension such that when a low force is pulling on the leash 150, 152, the leash retracts back onto the wheel 134a, 134b.

The device 110 includes a button 116 configured to be operatively and single-handedly depressed by a user. The button 116 can include, for example, but not limited to, a push handle, or the like. The button 116 is configured with a hole 120 through which the button 116 is mounted securely on the axle 114. The device 110 includes a lock 118 coupled to the button 116. The lock 118 can be a lock bar, clamp, or other locking mechanism sufficient to stop extension of the leashes. The lock 118 is configured to push together the first and second wheels 134a, 134b and to lock and stop rotation of the wheels 134a, 134b as the button 116 is operatively depressed by the user. The button 116 is mounted on the axle 114 to secure the button 116 to the axle 114 and to a handle 112 coupled to the axle 114.

The device 110 can include a handgrip 160 disposed upon the handle 112. By way of example, the handgrip 160 can include a rubber-grooved handle. The handgrip 160 can include finger and palm indentations to conform to the hand of the operator. Additionally, in alternative embodiments, the device 110 and handle 112 can further include a hand or wrist strap.

The device 110 includes first and second housings 128a, 128b configured to mount upon the axle 114 through holes 130a, 130b and cover the first and second wheels 134a, 314b, respectively. The device includes a leash hole 132a, 132b disposed on each of the housings 128a, 128b such that the retracted leash 150, 152 extends from the wheel 134a, 134b through the hole 132a, 132b on extension of the leash and returns through the hole 132a, 132b to the wheel 134a, 134b on retraction of the leash. The leashes 150, 152 exiting the leash holes 132a, 132b in the first and second housings 128a, 128b thereby freely and independently rotate about the axle 114 as the attached leashes move and the first and second housings 128a, 128b rotate. As such, the point of exit for the leashes 150, 152 can vary and rotate dependent on movement of the leashes and the operator. The exit point for the leashes 150, 152 is not permanently fixed relative to the device 110. This provides greater flexibility is use and lessens the Likelihood of leash entanglement.

The device 110 includes a first bearing 122 coupled to the first housing 128a and configured to allow the first housing 128a to rotate about the axle 114. The first bearing 122 is configured with a hole 124 to receive the axle 114. The first bearing 122 is also configured with a lock hole 126 to receive the lock 118 such that the lock 118 accesses the first and second wheels 134a, 134b and, as the user depresses the button 116, locks the first and second wheels 134a, 134b to brake the extension of the leashes 150, 152.

The device 110 includes a second bearing 140 coupled to the second housing 128b and configured to allow the second housing 128b to rotate about axle 114. The second bearing is configured with a hole 142 to receive the axle 114.

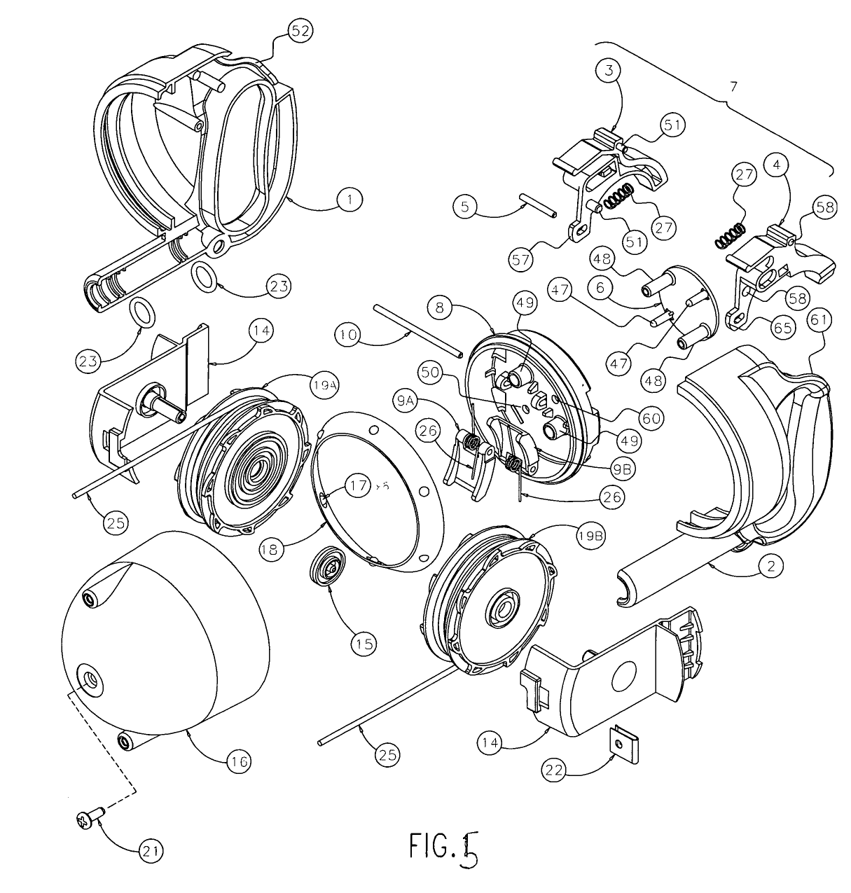

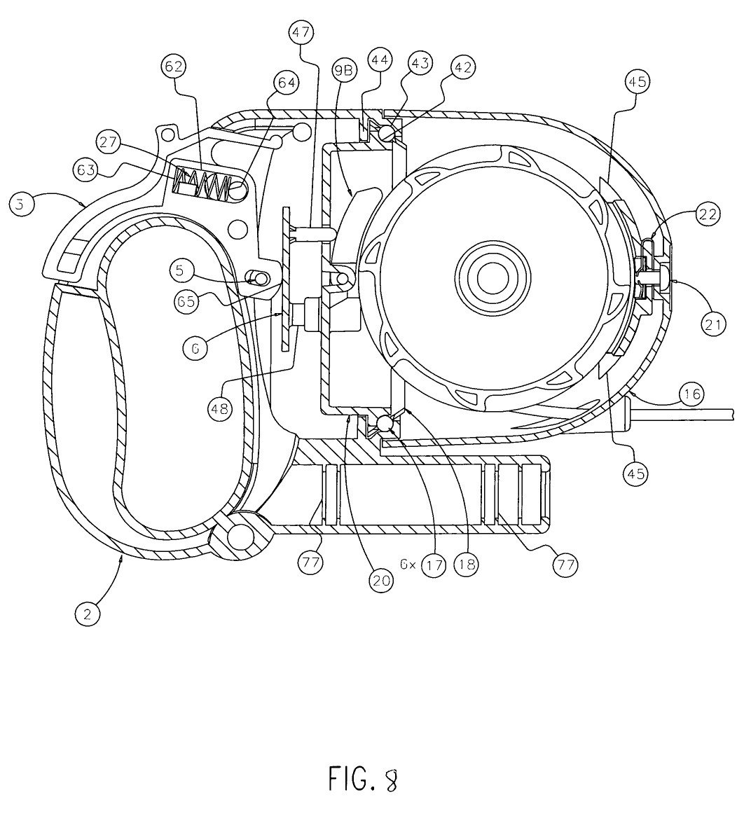

An alternative embodiment is illustrated in FIGS. 5 through 12. An exploded view of the alternative embodiment is shown in FIG. 5. The primary components of the alternative embodiment include a right handle housing 1 and a left handle housing 2, a brake housing 8 which includes a first and second stop saddle for assisting in braking leash reels 19A and 19B. Brake buttons 3 and 4 interact with an actuating disk 6 for manipulating the first and second stop saddles for braking respective leash reels 19A and 19B. Leash reels 19A and 19B are mounted on leash reel mounting bracket 14 which are mounted within leash cover 16. Leash reel mounting bracket 14 includes a first and second tab member. The first tab member engages brake housing 8 and the second tab member slips over a boss rim within the left and right handle housings. When assembled, the leash reels, leash cover and brake assembly all rotate simultaneously along a track defined by the second tab member engaging the boss rim which circumferentially extends along the interior of the left and right handle housings.

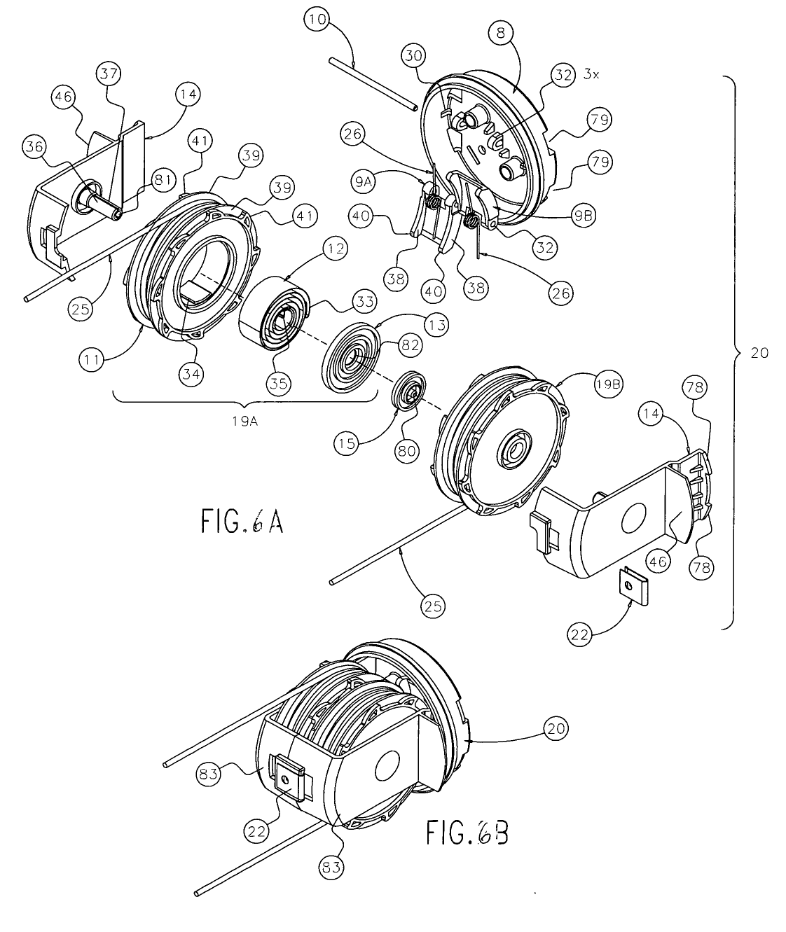

FIG. 6A illustrates a brake housing 8 into which are installed two stop saddles 9A and 9B which are mounted by means of a round shaft 10 which inserted through an access hole 30 in the side of the housing 8 and guided through a series of locating loops 31. In addition, the shaft 10 is guided through two holes 32 located at the base each stop saddle 9 as well as through a torsion spring 26. When installed, the torsion spring 26 causes the stop saddle 9 to rotate against the back inside of the housing 8; any forward rotation of the stop saddle 9 would therefore require a force greater than the torsional effect of the spring 26.

Referring to FIG. 6A, a spool assembly 19 comprised of a take-up spool 11 into which a constant force spring 12 is inserted in its center in such a manner that an anchor loop 33 on the outside of the spring 12 is positioned around an anchor tab 34 located on the inside edge of the center opening of the spool 11. Closer examination shows a formed end 35 on the inside end of the constant force spring 12, the function of which is to provide a means of securing a second anchor for the constant force spring 12. The constant force spring 12 is held in the take-up spool 11 by means of a circular spring cover 13 which provides access to the formed end 35 through a center access hole 82 in the spring cover 13. A length of braided rope or leash 25 is wrapped around the hub portion of the take-up spool 11 in a direction such that when the spool assembly 19 is properly anchored the leash 25 will retract to its original position when pulled.

Referring to FIG. 6A, the reel assembly 19 is mounted on a bearing post 36 of the reel mounting bracket 14. The post 36 includes a narrow longitudinal slit 37 for anchoring the formed end 35 of the constant force spring 12. The two reel mounting brackets 14 and the two reel assemblies 19 are identical and when assembled are mounted to the bearing ring housing by placing the reel mounting bracket tabs 78 of the reel mounting bracket 14 into the tab slots 79 on the perimeter of the bearing ring housing 8. To insure proper spacing between the facing reel assemblies 19, a spool spacing ring 15 is install between the two reel mounting brackets 14 by guiding a small boss 80 located on each side of the reel spacing ring 15 into a like size hole 81 at the end of bearing post 36.

Referring to FIG. 6A, the sides 38 of the stop saddle 9 are sufficiently spaced to fit over the outside edges 39 of the reel assembly 19. In the event the stop saddle 9 is rotated forward such that it straddles the edges 39 of the reel assembly 19, the tip of each saddle side 40 will engage any one of a plurality of cupped protrusions 41 that are part of the reel assembly 19 edge 39. As can be seen, this action will prevent the reel assembly 19 from rotating in the direction that allows the leash 25 to extend.

Referring to FIG. 6B, the sum of the components in FIG. 6A, when assembled, form a bearing ring assembly 20. The two identical halves 83 of the bearing ring assembly can be temporarily held together buy installing a single thread “U” clip fastener 22.

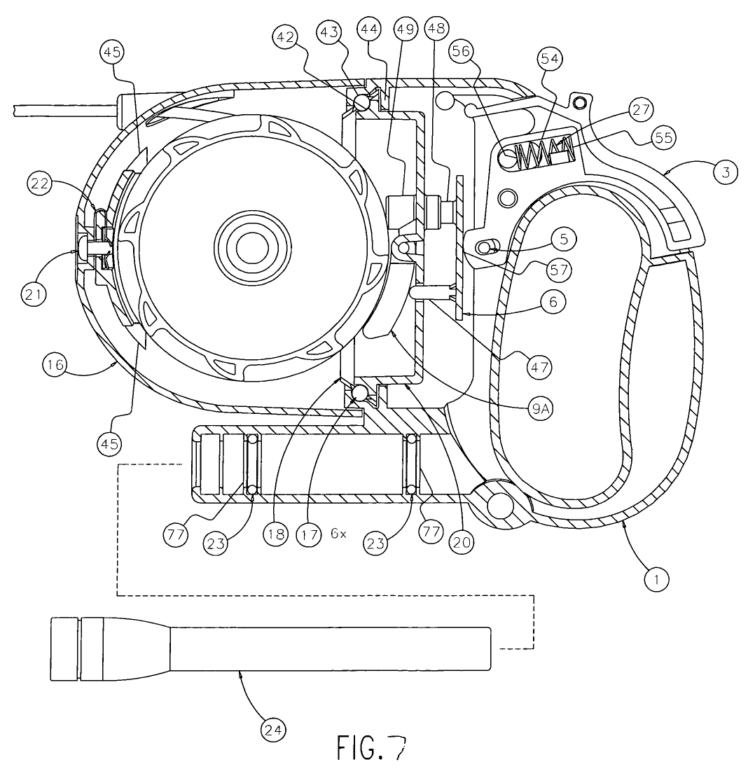

FIG. 7 depicts the right section of the invention in which the bearing ring assembly 20 is coupled to the right handle housing 1 by means of a multiple of balls 17 that are equally spaced by means of a ball separator 18 and held in place buy the confinement of a bearing race 42 in the ring assembly 20 and the opposing bearing race 43 in the right handle housing 1. Rearward movement of the ring assembly is prevented by a circular rib 44, part of the right handle housing 1. This arrangement allows the bearing ring assembly 20 and any part attached, such as the leash cover 16, to rotate 360 degrees with a minimum amount of friction. The leash cover 16 is accurately positioned over the bearing ring assembly 20 by means of cover support tabs 45 and spool mounting bracket fin 46 best depicted in FIG. 6A and is secured by the combination of a machine screw 21 and a single thread “U” clip fastener 22.

Referring to FIG. 7, two rubber o-rings 23 are secured between identical rib configurations 77 for holding an optional flashlight 24. Referring to FIGS. 5, 7, and 8, a single button assembly 7 is formed by guiding two similar bosses 51 affixed to the right hand button 3 into two corresponding holes 58 in the left hand button 4. The resulting button assembly 7 is held in place by the constraint of the side of the button opening 52 in the right handle housing 1, by the constraint of the side of the button opening 61 in the left handle housing 2 and by the button mounting shaft 5. A compression spring 27 is installed in a spring opening 54 in the right hand button 3 and in a spring opening 62 in the left hand button 4. These springs 27 force the button assembly 7 to maintain a position toward the rear of the handle housing 1 by contacting the rear of the spring opening 55 of the right button 3 and a spring post 56, part of the right handle housing 1. Likewise, spring 27 forces the button assembly 7 to maintain a position the rear of handle housing 2 by contacting the rear of the spring opening 63 of the left button 4 and the spring post 64, part of the left handle housing 2. The right button contact face 57 and the left button contact face 65 lightly touch the actuating disk 6 on the centerline of the bearing ring assembly 20. It can be seen that because the actuating disk 6 and the bearing ring assembly 20 are concentrically mounted, the right button contact face 57 and the left button contact face 65 will always be in contact with the center of the actuating disk 6 no matter what the position of the bearing ring assembly 20.

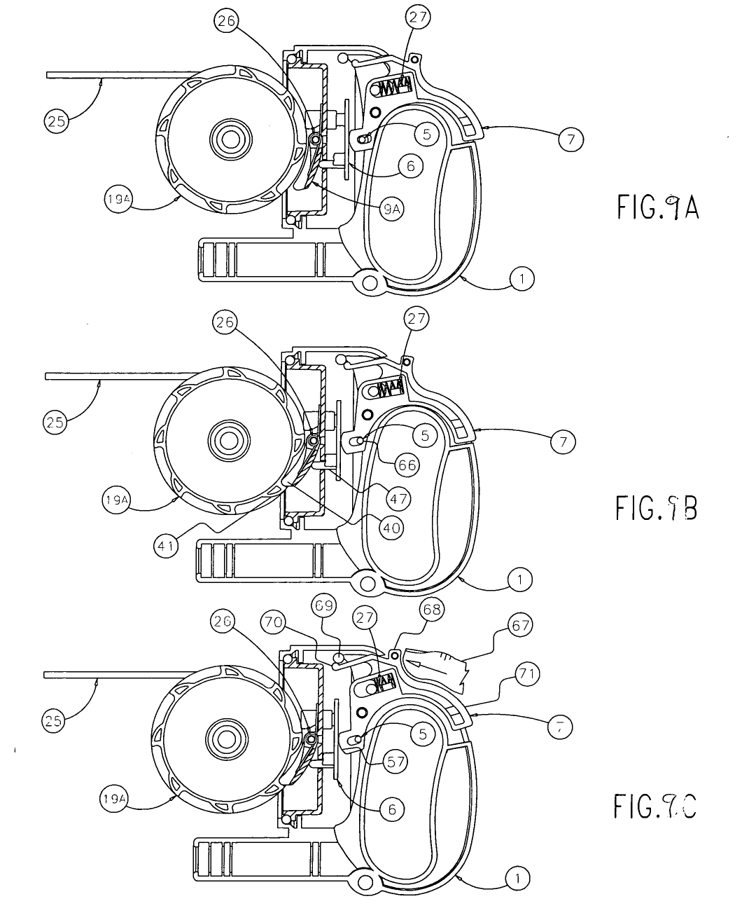

Referring to FIG. 9A, the button assembly 7 is shown in a neutral position in that it is positioned fully toward the rear of the right handle housing 1 and therefore the stop saddle 9A is rotated away from the spool assembly 19A by the action of the torsion spring 26 which in turn forces the actuating disk 6 to its maximum rearward position. In this situation the spool assembly 19A is free to rotate clockwise or counter-clockwise depending on the tension on the leash 25.

Referring to FIG. 9B, the button assembly 7 is shown in the activated position in that it is positioned fully to the left by overcoming the resistance of the compression spring 27 and the torsion spring 26, its movement limited by the constraints of the edge of the button mounting slot 66 and the button mounting shaft 5. The tips 40 of the stop saddle 9A are in full contact with the cupped protrusions 41 on the edges of the spool assembly 19A. The spool assembly 19A is now unable to rotate counter-clockwise and the leash 25 is prevented from extending as long as the right button 3 is held in this position.

Referring to FIG. 9C, the button assembly 7 is fully extended to the left and rotated approximately seven degrees counter-clockwise. This action is easily accomplished by pressing the button assembly 7 with the thumb 67 of either hand and rotating the thumb 67 against the button thumb stop 68 until the button locking tab 69 flexes under the right handle locking post 70. Persons familiar with the art will appreciate the fact that the right button contact face 57 is a full radius that has it center on the center of the button mounting shaft 5 thus any rotation of the button 3, as part of button assembly 7, has no negative impact on the position of the actuating disk 6. This locking action being accomplished, the spool assembly 19A is locked and the leash 25 cannot be extended or retrieved until the action is reversed by pressing the button assembly 7 firmly downward at or near the point 71.

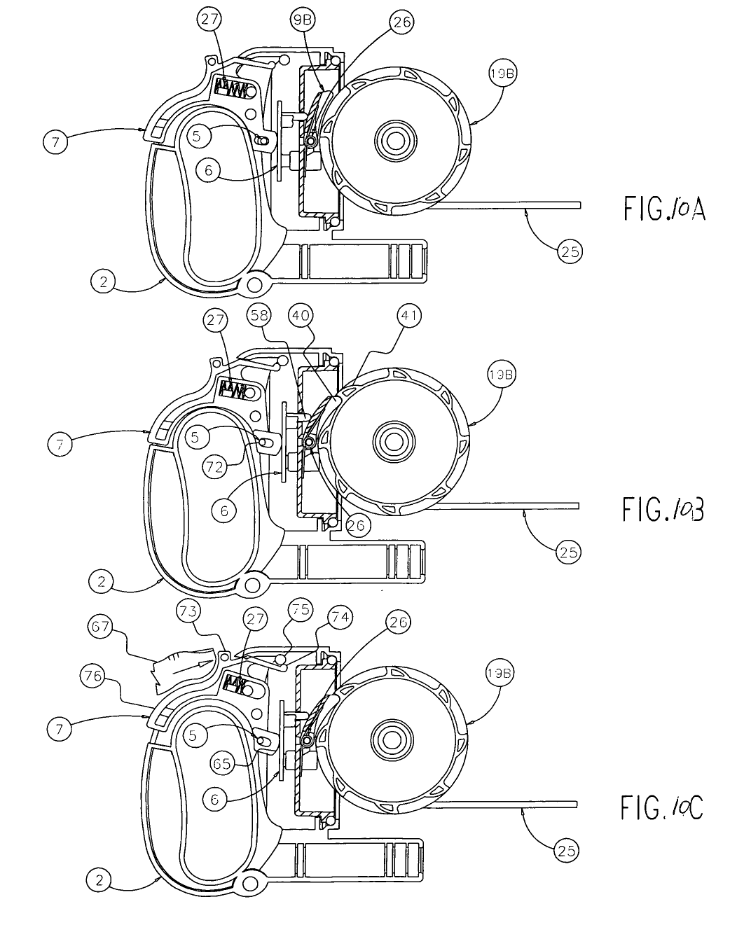

Referring to FIG. 10A, the button assembly 7 is shown in a neutral position in that it is positioned fully toward the rear of the left handle housing 2 and therefore the stop saddle 9B is rotated away from the spool assembly 19B by the action of the torsion spring 26 which in turn forces the actuating disk 6 to its maximum rearward position. In this state the spool assembly 19B is free to rotate clockwise or counter-clockwise depending on the tension on the leash 25.

Referring to FIG. 10B, the button assembly 7 is shown in the activated position in that it is positioned fully to the right by overcoming the resistance of the compression spring 27 and the torsion spring 26, its movement limited by the constraints of the edge of the button mounting slot 72 and the button mounting shaft 5. The tips 40 of the stop saddle 9B are in full contact with the cupped protrusions 41 on the edges of the spool assembly 19b. The spool assembly 19B is now unable to rotate counter-clockwise and the leash 25 is prevented from extending as long as the button assembly 7 is held in this position.

Referring to FIG. 10C, the button assembly 7 is fully extended to the right and rotated approximately seven degrees clockwise. This action is easily accomplished by pressing the button assembly 7 with the thumb 67 of either hand and rotating the thumb 67 against the button thumb stop 73 until the left button locking tab 74 flexes under the left handle locking post 75. Persons familiar with the art will appreciate the fact that the left button contact face 65 is a full radius that has it center on the center of the button mounting shaft 5 thus any rotation of the button 4, as part of the button assembly 7, has no negative impact on the position of the actuating disk 6. This locking action being accomplished, the spool assembly 19B is locked and the leash 25 cannot be extended or retrieved until the action is reversed by pressing the button assembly 7 firmly at or near the point 76.

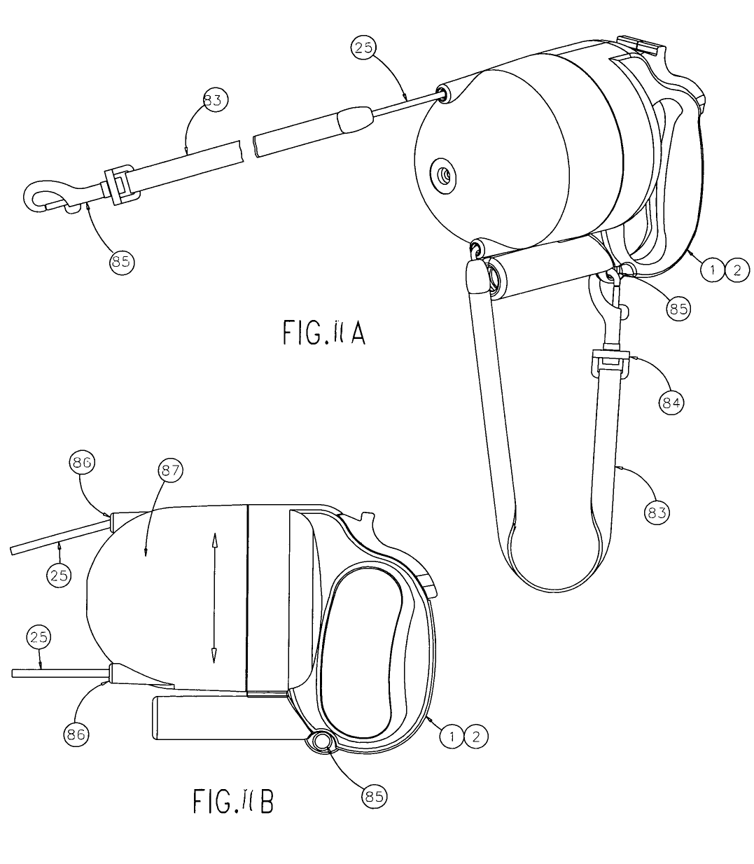

Referring to FIG. 11A, a leash extension 83, attached to the leash 25, includes a slide-bolt spring snap 84 that can be attached to a snap ring 85 provided at bottom of the combination of the right and left handle housings, 1 and 2 respectively. The purpose of which is to provide a convenient point to connect the leash extension 83 when the use of only one leash 25 is needed.

FIG. 11B depicts the two leash exits 86, integral part of the leash cover 16, that extend slightly beyond the rounded exterior surface 87 of the leash cover 16. In combination with the ability of the leash cover to rotate 360 degrees, these features (86 & 87) prevent the extended leashes 25 from crossing one another and becoming entangled.

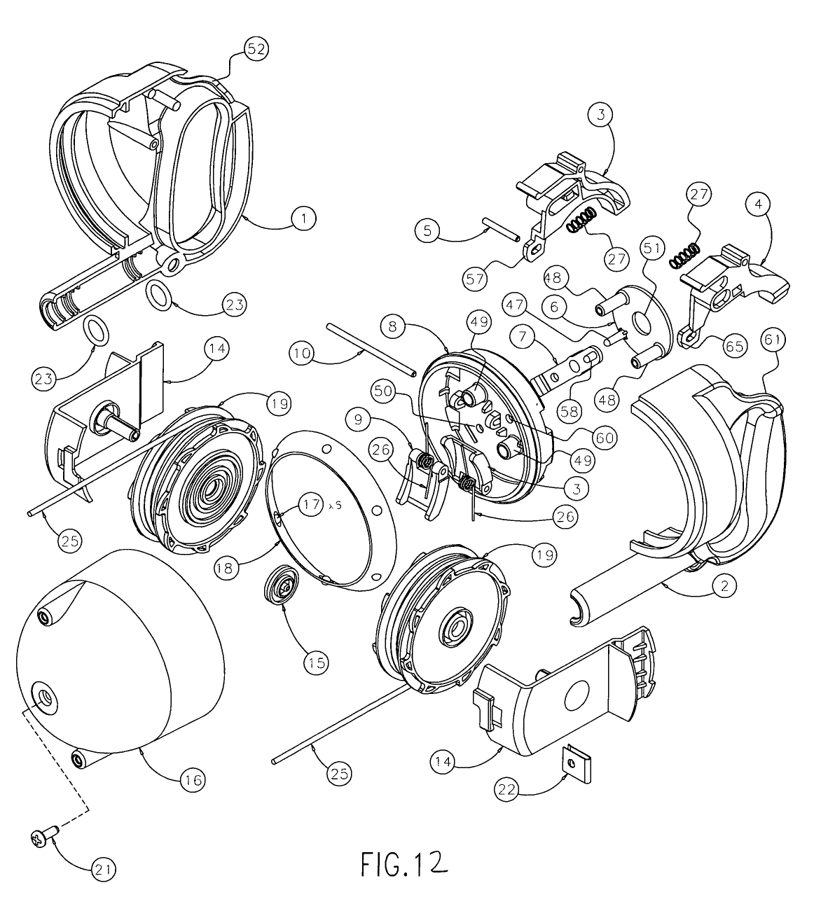

Referring to FIG. 12 an alternative braking arrangement is illustrated. One of the pair saddles 9 is acted upon by the movement of an actuating disk 6, which has affixed an actuating post 47 and two guide pins 48. The guide pins slide through two corresponding guide sleeves 49 that are part of the bearing ring housing 8. The actuating post 47 contacts the stop saddle 9 through an opening 50 in the bearing ring housing 8. In addition the actuating disk 6 has a centrally located opening 51 which allows access to an actuating lever 7. The actuating disk 6 is contacted by the right button 3 which is held in place by the constraints of the button opening 52 in the right handle housing 1 and the button mounting shaft 5. A compression spring 27 is installed in a spring opening 54 in the right button 3 which forces the button 3 to maintain a position toward the rear of the handle housing 1 by contacting the rear of the spring opening 55 on one side and a spring post 56, part of the right handle housing 1, on the opposing side. The right button contact face 57 lightly touches the actuating disk 6 on the vertical centerline of the bearing ring assembly 22 and to the immediate right of the centrally located opening 51 in the actuating disk 6. It can be seen that because the actuating disk 6 is cylindrical and affixed to the centrally positioned bearing ring assembly 20, the right button contact face 57 will always be in contact to the immediate right of the opening 51 no matter what the position of the bearing ring assembly 20. One of the pair saddles 9 is acted upon by the movement of an actuating lever 7, which has affixed an actuating post 58 and a raised housing 59. The housing 59 is of a diameter such that it will not contact the sides of the centrally located opening 51 in the actuating disk 6. The actuating post 58 contacts the stop saddle 9 through an opening 60 in the bearing ring housing. The actuating lever housing 59 is contacted by the left button 4 which is held in place by the constraints of the button opening 61 in the left handle housing 2 and the button mounting shaft 5. A compression spring 27 is installed in a spring opening 62 in the left button 4 which forces the button 4 to maintain a position toward the rear of the handle housing 2 by contacting the rear of the spring opening 63 on one side and a spring post 64, part of the left handle housing 2, on the opposing side. The left button contact face 65 lightly touches the housing 59 of the actuating lever 7 on the centerline of the bearing ring assembly 20. It can be shown that because left button 4 contact face 65 is on the same centerline as the housing 59 of the actuating lever 7 and the centrally positioned bearing ring assembly 20. It can be demonstrated that the left button contact face 65 will always be in contact with the center actuating lever housing 59 no matter what the position of the bearing ring assembly 20.

Accordingly in operation, the two leashes are intended to be dispensed on opposite sides of the leash device. In this manner, maximum spacing between the respective leashes is maintained. The swiveling concept of the leash cover, leash reels and braking system enables the leashes to maintain their separation as the leash cover, and other components, will rotate if one of the leashed animals changes orientation and the subsequent orientation of the leash by moving. Even if one of the leashed animals moves, the swiveling of the leash cover simultaneously displaces the second leash and maintains the separation of the respective leashes. Since the leash reels are fixed within the leash cover, they can maintain a 360 degree of rotation and always maintain their respective orientation with one another. Finally, since the braking assembly is also interconnected with the rotating leash cover and leash reels, the braking of the respective reels can be maintained utilizing a dedicated braking button configuration.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A leash device comprising:
a handle;
a housing rotatably carried by said handle, said housing having an interior and at least a first and second aperture communicating said interior with said ambient environment;
at least a first and second leash reel carried within said housing interior;
said first and second leash reels each carrying a respective leash and being independently rotatable enabling a respective leash to extend through a respective aperture of said housing; and
a brake for inhibiting the rotational movement of at least one reel.

2. The device of claim 1 wherein said housing includes a first and second housing component each having an interior and an aperture, said first reel carried within said first housing component and said second reel carried within said second housing component.

3. The device of claim 2 further including a first bearing, the first bearing coupled to the first housing and configured to allow the first housing to rotate about the axle; and
a second bearing, the second bearing coupled to the second housing and configured to allow the second housing to rotate about axle;
wherein each of the first and second bearings has an axle hole.

4. The device of claim 2 wherein said aperture of said first housing is disposed on a first side of said device and said aperture of said second housing is disposed on a second side of said device.

5. The device of claim 1 wherein said first and second reels are carried by said housing such that when said housing rotates with respect to said handle, said first and second reels rotate simultaneously with the corresponding rotation of said housing.

6. The device of claim 1 further comprising a button, the button configured to be operatively, single-handedly depressed by a user; and a lock, coupled to the button, the lock configured to push together the first and second wheels and to lock and stop rotation of the wheels as the button is operatively depressed by the user and define said brake.

7. A no-tangle, retractable leash for more than one tethered entity, the leash comprising:
a handle;
a handgrip disposed upon the handle;
an axle, the axle coupled to the handle;
first and second reels, mounted on the axle, configured to rotate independently on the axle, and each reel configured to hold a leash and to retract the leash when low tension on the leash exists;
a button, disposed adjacent to the handle, the button configured to be operatively, single-handedly depressed by a user; and
a lock, coupled to the button and generally parallel to the axle, the lock configured to push together the first and second wheels to lock and stop rotation of the wheels, as the button is depressed by the user.

8. The no-tangle, retractable leash for more than one tethered entity of claim 7, further comprising:
first and second housings, the housings configured to cover the first and second wheels, respectively; and
a leash hole disposed on each of the housings such that the retracted leash extends through the hole from the wheel on extension of the leash and returns through the hole to the wheel on retraction of the leash.

9. A leash device comprising:
a handle;
a housing rotatably carried by said handle, said housing having an interior and at least a first and second aperture communicating said interior with said ambient environment;
at least a first and second leash reel carried within said housing interior and mounted for rotating simultaneously with said housing;
said first and second leash reels each carrying a respective leash and being independently rotatable enabling a respective leash to extend through a respective aperture of said housing; and
a brake for inhibiting the rotational movement of at least one reel.

10. The leash device of claim 9 wherein said brake includes a first braking element for engaging said first leash reel and a second braking element for engaging said second leash reel.

11. The leash device of claim 10 including a braking actuator which includes at least a brake button and an intermediary actuating disk, said brake button engaging said intermediary actuating disk forcing said actuating disk to manipulate at least a first braking element to engage a first leash reel for braking the rotational movement of said first leash reel.

12. The leash device of claim 11 wherein said first leash reel includes cupped protrusions and said first braking element includes a stop saddle which interact with said cupped protrusions of said first leash reel prohibiting the rotation of said first leash reel.

13. The leash device of claim 11 including a second brake button and a second intermediary actuating disk, said second brake button engaging said second intermediary actuating disk forcing said second intermediary actuating disk to manipulate at least a second braking element to engage a second leash reel for braking the rotational movement of said second leash reel.

14. The leash device of claim 10 wherein said first and second braking elements engage said first and second leash reels simultaneously upon actuation of a braking actuator.

15. The leash device of claim 10 wherein said first and second braking elements rotate simultaneously with said leash housing and said first and second leash reels maintaining axial alignment between said respective leash reel and braking element such that said first braking element always is capable of engaging said first leash reel and said second braking element is always capable of engaging said second leash reel.

16. The leash device of claim 9 wherein said leash housing includes a compartment for housing a light source for illumination.

17. The leash device of claim 9 wherein said first and second apertures are disposed on opposite sides of said leash housing approximately one hundred and eighty degrees apart along a common plane.

18. The leash device of claim 17 wherein said first leash reel rotates in one direction when dispensing a leash, and said second leash reel rotates in an opposite direction when dispensing a leach enabling the first and second leash reels to be mounted adjacent to one another while dispensing said leashes approximately one hundred and eighty degrees apart along a common plane.

19. The leash device of claim 9 further including a handle assembly for carrying said handle and a ring carried by said handle assembly for receiving a leash when only one animal is tethered to said leash device.
